(19) United States
(12) Patent Application Publication
(10) Pub. No.: US 2008/0040752 A1
(43) Pub. Date: Feb. 14, 2008

(54) Content reception apparatus and method, program, and storage medium

(75) Inventor: Tsutomu Kawana, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/891,239

(22) Filed: Aug. 9, 2007

(30) Foreign Application Priority Data
Aug. 11, 2006 (JP) JP2006-219302

(51) Int. Cl. G06F 3/00

(52) U.S. Cl. 725/58

(57) ABSTRACT

Disclosed herein is a content reception apparatus for receiving content broadcast on a given channel in a given time period, the apparatus including: a display control section configured to control display of a screen for accepting scheduling of content to be received based on a program guide; and a storage section configured to store information concerning the content to be received, the content having been scheduled by a user based on the display of the screen. The display control section controls to display a time period in which the previously scheduled content is broadcast, in a display style different from other time period(s) in the program guide displayed on the screen. The display control section also controls to display the information concerning the previously scheduled content stored in the storage section in a predetermined area on the screen.

### CROSS REFERENCES TO RELATED APPLICATIONS

The present invention contains subject matter related to Japanese Patent Application JP 2006-219302, filed in the Japan Patent Office on Aug. 11, 2006, the entire contents of which being incorporated herein by reference.

### BACKGROUND OF THE INVENTION

1. Field of the Invention

The present invention relates to a content reception apparatus and method, a program therefor, and a storage medium having the program stored therein. In particular, the present invention relates to a content reception apparatus and method, a program therefor, and a storage medium having the program stored therein, which enable more efficient viewing or listening of recorded content.

2. Description of the Related Art

In recent years, a technology of scheduled recording of a program using an electronic program guide, such as an EPG (Electronic Program Guide), has become widespread. In the case where scheduling of a program has been performed using the electronic program guide, the scheduled program is, for example, attached with a mark indicative of scheduling to differentiate the scheduled program from the other unscheduled programs.

Unfortunately, however, the size of a display screen of a television receiver or the like is limited, and thus, the number of channels and the number of programs that can be displayed on one screen are naturally limited. In recent years, the number of receivable channels has been increasing, and thus, when a user schedules the recording using the electronic program guide displayed on the display screen, for example, the user often has to scroll the electronic program guide. As a result of scrolling the electronic program guide on the display screen, the scheduled program may disappear from the screen. If this happens, the user may not recognize the mark attached to the scheduled program, resulting in inability to identify the scheduled program.

As such, in order to prevent scheduling of the recording of a program that at least partly overlaps in time period with the program that has been previously scheduled for recording, a technique has been proposed of displaying an error indication if the user attempts to perform such overlapping scheduling (see Japanese Patent Laid-open No. 2005-191944).

### SUMMARY OF THE INVENTION

In related art, however, in the case where the error indication for the overlapping scheduling is displayed immediately before the user completes an operation of setting a schedule of the recording, the user may have an impression of lack of usability. Therefore, it is desirable that viewing the electronic program guide enable the user to identify the time period of the previously scheduled program.

In addition, related-art techniques involve a problem of lack of operability in the following respects as well. That is, when the aforementioned overlapping of scheduling has occurred, the user may desire to check the previously scheduled program that at least partly overlaps in time period with a program that the user has just attempted to schedule for recording using the electronic program guide, or cancel the scheduling of the previously scheduled program. In this case, the user has to switch to a screen displaying setting information concerning a recording schedule or the like, and, after completing the check or cancellation, cause the electronic program guide to be displayed again to start the new scheduling for recording afresh.

According to the present invention, it is desirable to facilitate the scheduling by use of the electronic program guide.

According to a first embodiment of the present invention, there is provided a content reception apparatus for receiving content broadcast on a given channel in a given time period, the apparatus including: a display control section configured to control display of a screen for accepting scheduling of content to be received based on a program guide; and a storage section configured to store information concerning the content to be received, the content having been scheduled by a user based on the display of the screen wherein the display control section controls to display a time period in which the previously scheduled content is broadcast, in a display style different from other time period(s) in the program guide displayed on the screen, and wherein the display control section controls to display the information concerning the previously scheduled content stored in the storage section in a predetermined area on the screen.

In the case where an instruction for canceling the scheduling of the previously scheduled content is accepted, the instruction being from the user and based on the display of the screen, the information concerning the previously scheduled content being displayed in the predetermined area on the screen, the storage section may be allowed to store information of content that is broadcast in a time period that at least partly overlaps with the time period in which the previously scheduled content is broadcast.

According to the first embodiment of the present invention, there is provided a content reception method of a content reception apparatus for receiving content broadcast on a given channel in a given time period, the content reception method including the steps of: displaying a time period in which content scheduled by a user based on display of a screen for accepting scheduling of content to be received based on a program guide is broadcast in a display style different from other time period(s) in the program guide displayed on the screen, information concerning the scheduled content being stored as information of the content to be received; and displaying the information concerning the previously scheduled content in a predetermined area on the screen.

According to the first embodiment of the present invention, there is provided a computer-readable program for making a content reception apparatus for receiving content broadcast on a given channel in a given time period to execute a content reception process including the steps of: displaying a time period in which content scheduled by a user based on display of a screen for accepting scheduling of content to be received based on a program guide is broadcast in a display style different from other time period(s) in the program guide displayed on the screen, information concerning the scheduled content being stored as information of the content to be received; and displaying the information concerning the previously scheduled content in a predetermined area on the screen.

In the first embodiment of the present invention, a time period in which content scheduled by a user based on display of a screen for accepting scheduling of content to be received based on a program guide is broadcast is caused to be displayed in the program guide displayed on the screen in different display style from another time period, information concerning the scheduled content being stored as information of the content to be received; and the information concerning the previously scheduled content is caused to be displayed in a predetermined area on the screen.

According to a second embodiment of the present invention, there is provided a content reception apparatus for receiving content broadcast on a given channel in a given time period, the apparatus including: a display control section configured to control display of a screen for accepting scheduling of content to be received based on a program guide; and a storage section configured to store information concerning the content to be received, the content having been scheduled by a user based on the display of the screen; wherein the display control section controls to display content that is broadcast in a time period that at least partly overlaps with a time period in which the previously scheduled content is broadcast in different display style from other piece(s) of content in the program guide displayed on the screen, and wherein the display control section controls to display the information concerning the previously scheduled content stored in the storage section in a predetermined area on the screen.

In the case where an instruction for canceling the scheduling of the previously scheduled content is accepted, the instruction being from the user and based on the display of the screen, the information concerning the previously scheduled content being displayed in the predetermined area on the screen, the storage section may be allowed to store information of content that is broadcast in a time period that at least partly overlaps with the time period in which the previously scheduled content is broadcast.

According to the second embodiment of the present invention, there is provided a content reception method of a content reception apparatus for receiving content broadcast on a given channel in a given time period, the content reception method including the steps of: displaying content that is broadcast in a time period that at least partly overlaps with a time period in which content scheduled by a user based on display of a screen for accepting scheduling of content to be received based on a program guide is broadcast in different display style from other piece(s) of content in the program guide displayed on the screen, information concerning the scheduled content being stored as information of the content to be received; and displaying the information concerning the previously scheduled content in a predetermined area on the screen.

According to the second embodiment of the present invention, there is provided a computer-readable program for making a content reception apparatus for receiving content broadcast on a given channel in a given time period to execute a content reception process including the steps of: displaying content that is broadcast in a time period that at least partly overlaps with a time period in which content scheduled by a user based on display of a screen for accepting scheduling of content to be received based on a program guide is broadcast in different display style from other piece(s) of content in the program guide displayed on the screen, information concerning the scheduled content being stored as information of the content to be received; and displaying the information concerning the previously scheduled content in a predetermined area on the screen.

In the second embodiment of the present invention, content that is broadcast in a time period that at least partly overlaps with a time period in which content scheduled by a user based on display of a screen for accepting scheduling of content to be received based on a program guide is broadcast is caused to be displayed in the program guide displayed on the screen in different display style from another piece of content, information concerning the scheduled content being stored as information of the content to be received; and the information concerning the previously scheduled content is caused to be displayed in a predetermined area on the screen.

According to a third embodiment of the present invention, there is provided a content reception apparatus for receiving content broadcast on a given channel in a given time period, the apparatus including: a display control section configured to control display of a screen for accepting scheduling of content to be received based on a program guide; and a storage section configured to store information concerning the content to be received, the content having been scheduled by a user based on the display of the screen; wherein the display control section controls to display a time period in which the previously scheduled content is broadcast, in a display style different from other time period(s) in the program guide displayed on the screen, and also displays content that is broadcast in a time period that at least partly overlaps with the time period in which the previously scheduled content is broadcast in different display style from other piece(s) of content in the program guide displayed on the screen, and wherein the display control section controls to display the information concerning the previously scheduled content stored in the storage section in a predetermined area on the screen.

In the case where an instruction for canceling the scheduling of the previously scheduled content is accepted, the instruction being from the user and based on the display of the screen, the information concerning the previously scheduled content being displayed in the predetermined area on the screen, the storage section may be allowed to store information of content that is broadcast in a time period that at least partly overlaps with the time period in which the previously scheduled content is broadcast.

According to the third embodiment of the present invention, there is provided a content reception method of a content reception apparatus for receiving content broadcast on a given channel in a given time period, the content reception method including the steps of: displaying a time period in which content scheduled by a user based on display of a screen for accepting scheduling of content to be received based on a program guide is broadcast in a display style different from other time period(s) in the program guide displayed on the screen, information concerning the scheduled content being stored as information of the content to be received; displaying content that is broadcast in a time period that at least partly overlaps with the time period in which the scheduled content is broadcast in different display style from other piece(s) of content in the program guide displayed on the screen; and displaying the information concerning the previously scheduled content in a predetermined area on the screen.

According to the third embodiment of the present invention, there is provided a computer-readable program for making a content reception apparatus for receiving content broadcast on a given channel in a given time period to execute a content reception process including the steps of: displaying a time period in which content scheduled by a user based on display of a screen for accepting scheduling of content to be received based on a program guide is broadcast in a display style different from other time period(s) in the program guide displayed on the screen, information concerning the scheduled content being stored as information of the content to be received; displaying content that is broadcast in a time period that at least partly overlaps with the time period in which the scheduled content is broadcast in different display style from other piece(s) of content in the program guide displayed on the screen; and displaying the information concerning the previously scheduled content in a predetermined area on the screen.

In the third embodiment of the present invention, a time period in which content scheduled by a user based on display of a screen for accepting scheduling of content to be received based on a program guide is broadcast is caused to be displayed in the program guide displayed on the screen in different display style from another time period, information concerning the scheduled content being stored as information of the content to be received; content that is broadcast in a time period that at least partly overlaps with the time period in which the scheduled content is broadcast is caused to be displayed in the program guide displayed on the screen in different display style from another piece of content; and the information concerning the previously scheduled content is caused to be displayed in a predetermined area on the screen.

According to a fourth embodiment of the present invention, there is provided a content reception apparatus for receiving content broadcast on a given channel in a given time period, the apparatus including: a display control section configured to control display of a screen for accepting scheduling of content to be received based on a program guide that is displayed in a state that allows scrolling at least in a time-axis direction; and a storage section configured to store information concerning the content to be received, the content having been scheduled by a user based on the display of the screen; wherein the display control section controls to display content that is broadcast in a time period that at least partly overlaps with a time period in which the previously scheduled content is broadcast in different display style from other piece(s) of content in the program guide displayed on the screen.

According to the fourth embodiment of the present invention, there is provided a content reception method of a content reception apparatus for receiving content broadcast on a given channel in a given time period, the method including the step of: displaying content that is broadcast in a time period that at least partly overlaps with a time period in which content scheduled by a user based on display of a screen for accepting scheduling of content to be received based on a program guide that is displayed in a state that allows scrolling at least in a time-axis direction is broadcast in different display style from other piece(s) of content in the program guide displayed on the screen, information concerning the scheduled content being stored as information of the content to be received.

According to the fourth embodiment of the present invention, there is provided a computer-readable program for making a content reception apparatus for receiving content broadcast on a given channel in a given time period to execute a content reception process including the step of: displaying content that is broadcast in a time period that at least partly overlaps with a time period in which content scheduled by a user based on display of a screen for accepting scheduling of content to be received based on a program guide that is displayed in a state that allows scrolling at least in a time-axis direction is broadcast in different display style from other piece(s) of content in the program guide displayed on the screen, information concerning the scheduled content being stored as information of the content to be received.

In the fourth embodiment of the present invention, content that is broadcast in a time period that at least partly overlaps with a time period in which content scheduled by a user based on display of a screen for accepting scheduling of content to be received based on a program guide that is displayed in a state that allows scrolling at least in a time-axis direction is broadcast is caused to be displayed in the program guide displayed on the screen in different display style from another piece of content, information concerning the scheduled content being stored as information of the content to be received.

According to the present invention, scheduling using the electronic program guide is made easier.

The above and other features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram illustrating an exemplary structure of a television broadcast reception apparatus according to one embodiment of the present invention;

FIG. 2 illustrates an exemplary display of an electronic program guide;

FIG. 3 illustrates an exemplary display of the electronic program guide obtained by scrolling a screen in a situation as illustrated in FIG. 2 in a vertical direction (downward);

FIG. 4 illustrates an exemplary display of the electronic program guide obtained by scrolling the screen in the situation as illustrated in FIG. 2 in a horizontal direction (rightward);

FIG. 5 illustrates an exemplary display of the electronic program guide in the case where an operation of newly scheduling a program is performed in the screen of FIG. 4;

FIG. 6 is an illustration for explaining an exemplary case where cancellation of scheduling of a program is performed in the screen of FIG. 5;

FIG. 7 is a flowchart for explaining an electronic program guide display procedure;

FIG. 8 is a flowchart for explaining a scheduling cancellation procedure; and

FIG. 9 is a block diagram illustrating an exemplary structure of a personal computer.

### DETAILED DESCRIPTION OF THE PREFERRED EMBODIMENTS

Hereinafter, embodiments of the present invention will be described. Correspondence between the constituent features of the present invention and the embodiments that will be described below in this specification taken in conjunction with the accompanying drawings is exemplified as follows. Note that this preliminary description is meant to confirm that an embodiment that supports the present invention is described in this specification and the accompanying drawings. Therefore, even if there is an embodiment that is described in this specification and the accompanying drawings but not described in this preliminary description as corresponding to a constituent feature of the present invention, that does not mean that that embodiment does not correspond to that constituent feature. Conversely, even if a certain embodiment is described in this preliminary description as corresponding to a certain constituent feature of the present invention, that does not mean that the certain embodiment does not correspond to any other constituent feature.

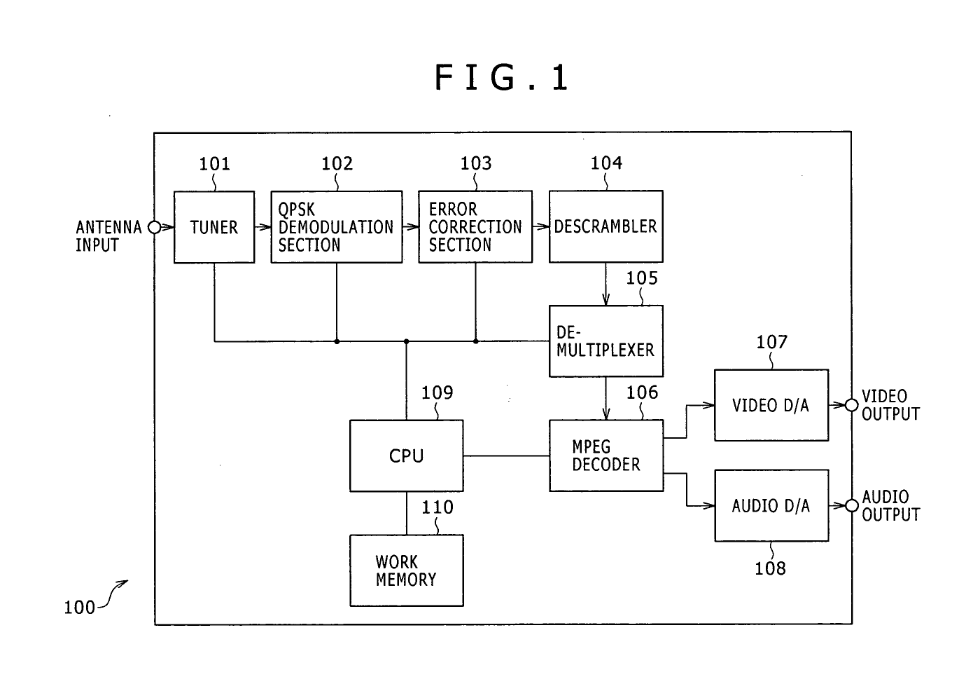

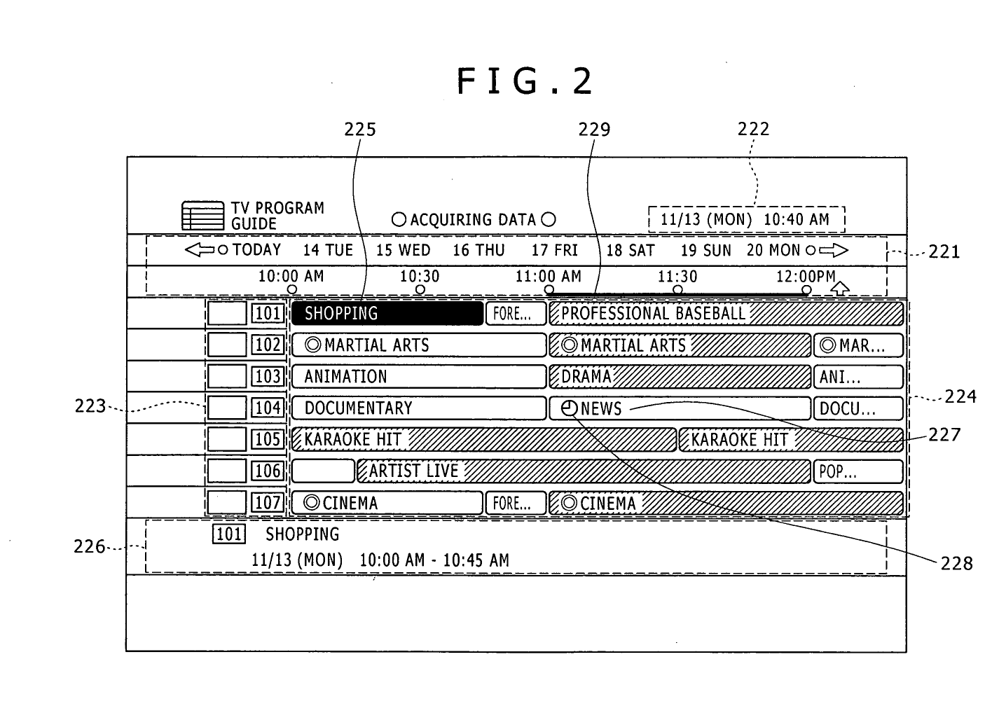

A content reception apparatus according to a first embodiment of the present invention is a content reception apparatus for receiving content broadcast on a given channel in a given time period, the apparatus including: a display control section (e.g., a CPU 109 in FIG. 1 for controlling display of a screen of FIG. 2) configured to control display of a screen for accepting scheduling of content to be received based on a program guide; and a storage section (e.g., a work memory 110 in FIG. 1) configured to store information concerning the content to be received, the content having been scheduled by a user based on the display of the screen; wherein the display control section controls to display a time period in which the previously scheduled content is broadcast, in a display style different from other time period(s) in the program guide displayed on the screen, and wherein the display control section control to display the information concerning the previously scheduled content stored in the storage section in a predetermined area on the screen.

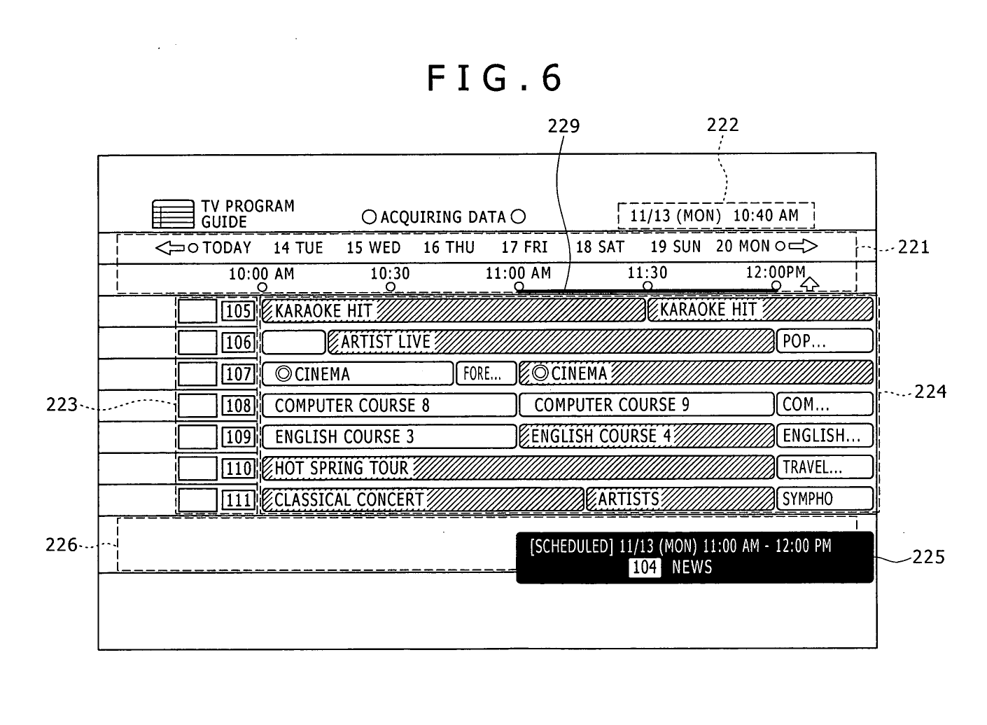

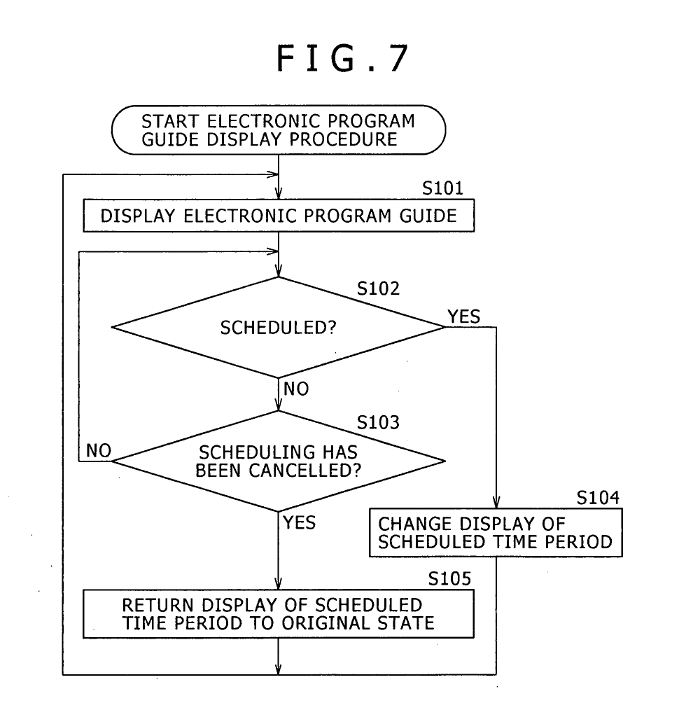

A content reception method according to the first embodiment of the present invention is a content reception method of a content reception apparatus for receiving content broadcast on a given channel in a given time period, the method including the steps of: displaying a time period in which content scheduled by a user based on display of a screen for accepting scheduling of content to be received based on a program guide is broadcast in a display style different from other time period(s) in the program guide displayed on the screen, information concerning the scheduled content being stored as information of the content to be received (e.g., a process of step S104 in FIG. 6); and displaying the information concerning the previously scheduled content in a predetermined area on the screen (e.g., a process of step S154 in FIG. 7).

A content reception apparatus according to a second embodiment of the present invention is a content reception apparatus for receiving content broadcast on a given channel in a given time period, the apparatus including: a display control section (e.g., the CPU 109 in FIG. 1 for controlling the display of the screen of FIG. 2) configured to control display of a screen for accepting scheduling of content to be received based on a program guide; and a storage section (e.g., the work memory 110 in FIG. 1) configured to store information concerning the content to be received, the content having been scheduled by a user based on the display of the screen; wherein the display control section controls to display content that is broadcast in a time period that at least partly overlaps with a time period in which the previously scheduled content is broadcast in different display style from other piece(s) of content in the program guide displayed on the screen, and wherein the display control section controls to display the information concerning the previously scheduled content stored in the storage section in a predetermined area on the screen.

A content reception method according to the second embodiment of the present invention is a content reception method of a content reception apparatus for receiving content broadcast on a given channel in a given time period, the method including the steps of: displaying content that is broadcast in a time period that at least partly overlaps with a time period in which content scheduled by a user based on display of a screen for accepting scheduling of content to be received based on a program guide is broadcast in different display style from other piece(s) of content in the program guide displayed on the screen, information concerning the scheduled content being stored as information of the content to be received (e.g., the process of step S104 in FIG. 6); and displaying the information concerning the previously scheduled content in a predetermined area on the screen (e.g., the process of step S154 in FIG. 7).

A content reception apparatus according to a third embodiment of the present invention is a content reception apparatus for receiving content broadcast on a given channel in a given time period, the apparatus including: a display control section (e.g., the CPU 109 in FIG. 1 for controlling the display of the screen of FIG. 2) configured to control display of a screen for accepting scheduling of content to be received based on a program guide; and a storage section (e.g., the work memory 110 in FIG. 1) configured to store information concerning the content to be received, the content having been scheduled by a user based on the display of the screen; wherein the display control section controls to display a time period in which the previously scheduled content is broadcast, in a display style different from other time period(s) in the program guide displayed on the screen, and also displays content that is broadcast in a time period that at least partly overlaps with the time period in which the previously scheduled content is broadcast in different display style from other piece(s) of content in the program guide displayed on the screen, and wherein the display control section controls to display the information concerning the previously scheduled content stored in the storage section in a predetermined area on the screen.

A content reception method according to the third embodiment of the present invention is a content reception method of a content reception apparatus for receiving content broadcast on a given channel in a given time period, the method including the steps of: displaying a time period in which content scheduled by a user based on display of a screen for accepting scheduling of content to be received based on a program guide is broadcast in a display style different from other time period(s) in the program guide displayed on the screen, information concerning the scheduled content being stored as information of the content to be received (e.g., the process of step S104 in FIG. 6); displaying content that is broadcast in a time period that at least partly overlaps with the time period in which the scheduled content is broadcast in different S display style from other piece(s) of content in the program guide displayed on the screen (e.g., the process of step S104 in FIG. 6); and displaying the information concerning the previously scheduled content in a predetermined area on the screen (e.g., the process of step S154 in FIG. 7).

A content reception apparatus according to a fourth embodiment of the present invention is a content reception apparatus for receiving content broadcast on a given channel in a given time period, the apparatus including: a display control section (e.g., the CPU 109 in FIG. 1 for controlling the display of the screen of FIG. 2) configured to control display of a screen for accepting scheduling of content to be received based on a program guide that is displayed in a state that allows scrolling at least in a time-axis direction; and a storage section (e.g., the work memory 110 in FIG. 1) configured to store information concerning the content to be received, the content having been scheduled by a user based on the display of the screen; wherein the display control section controls to display content that is broadcast in a time period that at least partly overlaps with a time period in which the previously scheduled content is broadcast in different display style from other piece(s) of content in the program guide displayed on the screen.

A content reception method according to the fourth embodiment of the present invention is a content reception method of a content reception apparatus for receiving content broadcast on a given channel in a given time period, the method including the step of: displaying content that is broadcast in a time period that at least partly overlaps with a time period in which content scheduled by a user based on display of a screen for accepting scheduling of content to be received based on a program guide that is displayed in a state that allows scrolling at least in a time-axis direction is broadcast in different display style from other piece(s) of content in the program guide displayed on the screen, information concerning the scheduled content being stored as information of the content to be received (e.g., the process of step S104 in FIG. 6).

Hereinafter, an embodiment of the present invention will be described with reference to the accompanying drawings.

FIG. 1 is a block diagram illustrating an exemplary structure of a television broadcast reception apparatus 100 according to one embodiment of the present invention.

As illustrated in FIG. 1, the television broadcast reception apparatus 100 is provided with a tuner 101 for receiving a signal supplied from an antenna that acquires a broadcast signal. The signal outputted from the tuner 101 is demodulated by a QPSK demodulation section 102. An output from the QPSK demodulation section 102 is supplied to an error correction section 103, and subjected therein to error detection, error correction, and, as necessary, compensation.

A descrambler 104 has stored therein a key, a program, etc., for decrypting scrambled broadcast data. In the case where the received broadcast signal is encrypted (i.e., scrambled), the descrambler 104 supplies the key or the like used for decrypting the encrypted (i.e., scrambled) signal to a demultiplexer 105. The demultiplexer 105 uses this key to decrypt (i.e., decode) the encrypted signal.

The demultiplexer 105 supplies the decrypted signal to a MPEG decoder 106. The MPEG decoder 106 decodes the signal, which has been compressed using an MPEG system. Of the decoded signal, a video signal is supplied to a video D/A (D/A converter) 107 to be converted to an analog video signal, and this analog video signal is supplied, as a video output signal, from the video D/A 107 to a display or the like connected to the television broadcast reception apparatus 100.

Meanwhile, of the signal decoded by the MPEG decoder 106, an audio signal is supplied to an audio D/A (D/A converter) 108 to be converted to an analog audio signal, and this analog audio signal is supplied, as an audio output signal, from the audio D/A 108 to a loudspeaker or the like connected to the television broadcast reception apparatus 100.

A CPU 109 controls the tuner 101, the QPSK demodulation section 102, the error correction section 103, the descrambler 104, the demultiplexer 105, and the MPEG decoder 106. The CPU 109 also controls display of an electronic program guide.

Specifically, the television broadcast reception apparatus 100 receives information contained in the broadcast signal, the information concerning a program that is currently broadcast and programs that will be broadcast in the future. Examples of such information include a 15 channel number, a channel name, a program title, a program start date and time, a length of a program (i.e., a broadcast time), a genre of the program, and detailed information of the program. The information is subjected to processes in the tuner 101, the QPSK demodulation section 102, the error correction section 103, the descrambler 104, and the demultiplexer 105, and then acquired by the CPU 109 to be stored in work memory 110. The CPU 109 uses the information stored in the work memory 110 to generate image data of the electronic program guide, so that an image of the electronic program guide is outputted as the video output signal.

As described above, the television broadcast reception apparatus 100 outputs video and/or audio of the program contained in the broadcast signal, and also, as necessary, the image of the electronic program guide contained in the broadcast signal.

FIG. 2 illustrates an exemplary display of the electronic program guide. In this exemplary display, information of programs broadcast on seven channels in a time period from a current time to two hours later is displayed in one screen. Note that this screen is displayed as a Graphical User Interface (GUI) for accepting a user's operation of program scheduling based on the electronic program guide.

In FIG. 2, a current date is November 13 (Monday), and the current time is 10:40 a.m.. An area 221 is an area in which are displayed dates from the current date (Monday) to seven days later and a two-hour time period corresponding to the current time, i.e., from 10:00 a.m. to 12:00 p.m.

An area 222 is an area in which the current date and time are displayed.

An area 223 is an area in which logos and channel numbers of receivable channels are displayed. The logos (marks) are displayed on the left-hand side (in the blanking cells), whereas the channel numbers (“101” to “107” in this example) are displayed on the right-hand side.

An area 224 is an area in which are displayed titles of programs that are broadcast during the time period displayed in the area 221 on the channels displayed in the area 223. In the area 224, frames enclosing the program titles represent broadcast times of the respective programs.

Displaying of a cursor 225 that causes a desired location on the electronic program guide displayed on the display to blink is also possible. In FIG. 2, the cursor 225 is located at a frame of a program “Shopping” displayed in the area 224. For example, the cursor 225 can be moved in four (up, down, left, right) directions by manipulation of a remote commander (not shown) or the like. In an area 226, information of the program at which the cursor 225 is located is displayed. This information is, for example, the channel number, the program title, a broadcast date, and program start and end times.

In the present example, channel number “101”, program title “Shopping”, broadcast date “November 13 (Mon)” (November 13 (Monday)), program start time “10:00 a.m.”, and program end time “10:45 a.m.” are displayed in the area 226.

For example, the user is able to cause the electronic program guide as illustrated in FIG. 2 to be displayed on the display or the like connected to the television broadcast reception apparatus 100, and move the cursor 225 by manipulating a key provided on the television broadcast reception apparatus 100, the remote commander, or the like to select or schedule a program on a desired channel.

In FIG. 2, a program having a program title “News” that is broadcast from 11:00 a.m. to 12:00 p.m. on November 13 on channel “104” has been scheduled previously, and an icon 228 indicating a previously scheduled program is displayed in a frame 227 enclosing the program title “News”. As described above, the electronic program guide is displayed such that the user, viewing the electronic program guide, is able to recognize that the program has been scheduled previously. Note that a method for indicating the previously scheduled program is not limited to displaying of the icon 228. For example, a background color of the frame 227 may be changed to a different color from those of the other frames to indicate the previously scheduled program.

Moreover, a bar 229 is displayed at a lower portion of the area 221 to indicate the time period of the previously scheduled program. In FIG. 2, the bar 229 is displayed at a position corresponding to the time period in which the previously scheduled program “News” is broadcast, i.e., from 11:00 a.m. to 12:00 p.m.

In FIG. 2, the information of the programs that are broadcast in the time period from the current time to two hours later on the seven channels are displayed in the one screen. However, when there is a desire to display information of a program that is broadcast on another channel than those displayed in FIG. 2, or when there is a desire to display information of a program that is broadcast in another time period that is outside of the time period displayed in FIG. 2, for example, the user is able to scroll the electronic program guide currently displayed on the screen by manipulating the remote commander or the like, thereby displaying the information of the program broadcast on the other channel or the information of the program broadcast in the other time period.

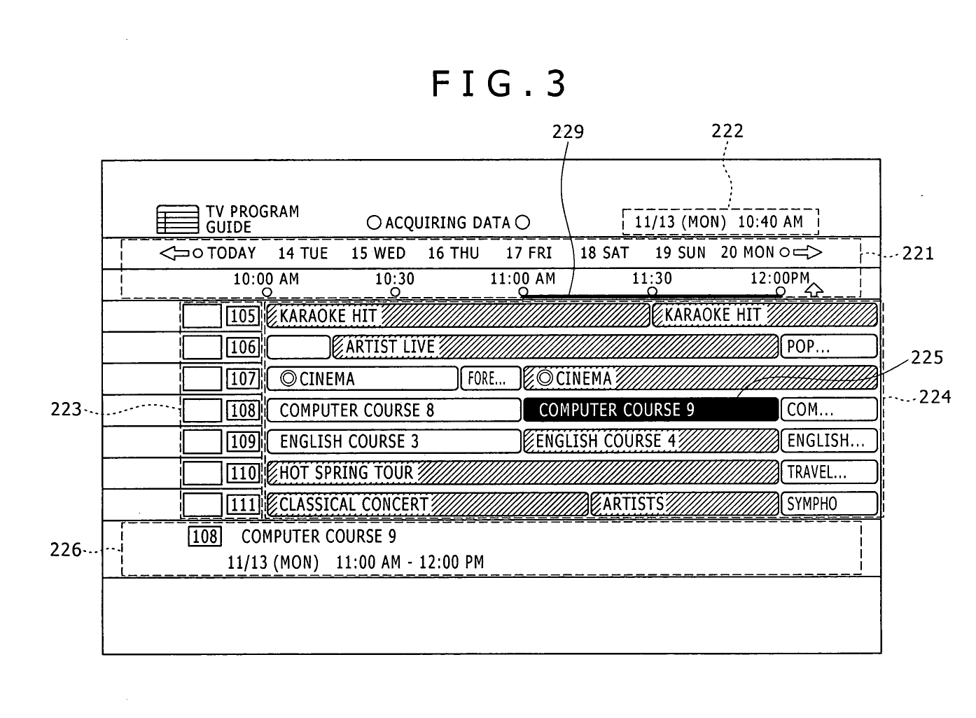

FIG. 3 illustrates an exemplary display of the electronic program guide obtained by scrolling the screen in a situation as illustrated in FIG. 2 in a vertical direction (downward). The scrolling of the screen in the vertical direction has not changed display of the area 221. That is, in FIG. 3, the dates from Monday to seven days later and the two-hour time period, from 10:00 a.m. to 12:00 p.m., are displayed in the area 221 as in FIG. 2. However, the scrolling of the screen in the vertical direction has changed display of the area 223. That is, dissimilar to FIG. 2, channel numbers “105” to “111” and logos of these channels are displayed in the area 223 in FIG. 3.

In addition, in FIG. 3, the cursor 225 is located at a frame of a program title “Computer Course 9” in the area 224, whereas in the area 226, the channel number, the program title, the broadcast date, and the program start and end times of a program “Computer Course 9” are displayed as information of this program.

As described above, the user is able to display the information of programs that are broadcast in the same time period but on other channels by scrolling the screen in the vertical direction.

When the electronic program guide has been scrolled as described above with an intention to schedule a program broadcast on another channel, the previously scheduled program “News” broadcast on channel “104” has disappeared from the screen as shown in FIG. 3. However, in the television broadcast reception apparatus 100 according to this embodiment of the present invention, the bar 229 is displayed at the lower portion of the area 221 to indicate the time period (i.e., from 11:00 a.m. to 12:00 p.m.) of the previously scheduled program. This prevents the user from attempting to schedule a program that at least partly overlaps in broadcast time with the previously scheduled program “News”, forgetting that the program “News” has been scheduled previously, for example.

Suppose, for example, that, in the television broadcast reception apparatus 100, the user performs an operation of scheduling a program that at least partly overlaps in broadcast time with the previously scheduled program, e.g., the program “Computer Course 9” that is broadcast from 11:00 a.m. to 12:00 p.m. on channel “108”. In this case, setting of this scheduling is not accepted, and an error message or the like is outputted. In this case, the user may desire to know why this scheduling operation has resulted in an error. In the present embodiment, since the bar 229 is displayed, the user is able to identify the time period in which any program has been scheduled previously even if the previously scheduled program has disappeared from the screen as a result of scrolling the electronic program guide.

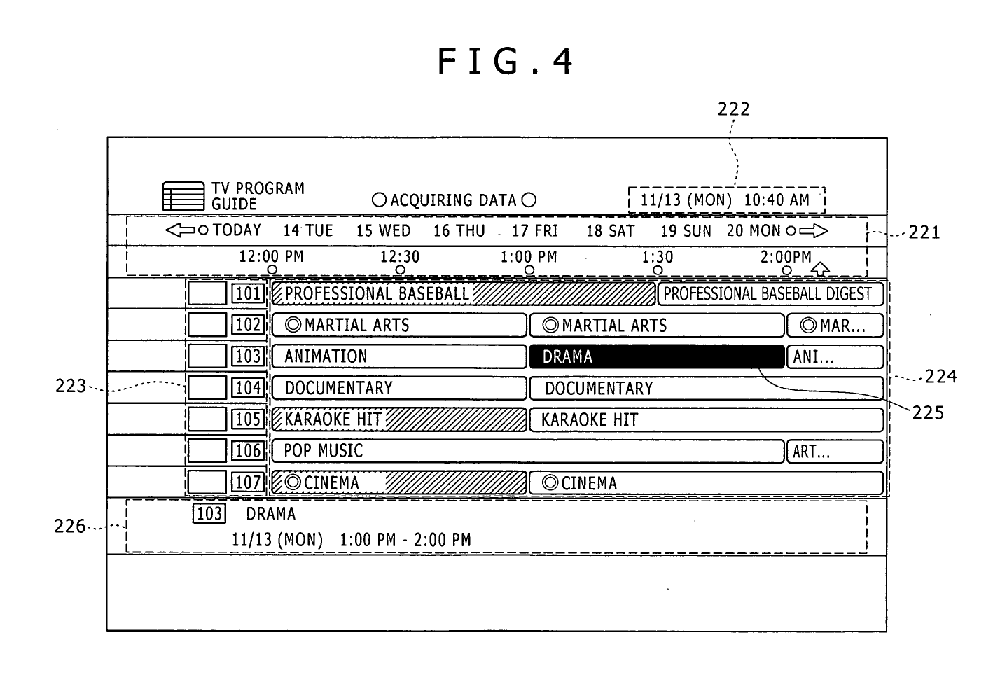

FIG. 4 illustrates an exemplary display of the electronic program guide obtained by scrolling the screen in the situation as illustrated in FIG. 2 in a horizontal direction (rightward). The scrolling of the screen in the horizontal direction has not changed the display of the area 223. That is, channel numbers “101” to “107” and the logos of these channels are displayed in the area 223 in FIG. 4 as in FIG. 2. However, the scrolling of the screen in the horizontal direction has changed the display of the area 221. That is, dissimilar to FIG. 2, the dates from Monday to seven days later and a two-hour time period from 12:00 p.m. to 2 p.m. are displayed in the area 221 in FIG. 4.

In addition, in FIG. 4, the cursor 225 is located at a frame of a program title “Drama” in the area 224, whereas in the area 226, the channel number, the program title, the broadcast date, and the program start and end times of a program “Drama” are displayed as information of this program.

As is apparent from FIG. 4, the scrolling of the electronic program guide in the horizontal direction will lead to disappearance of the bar 229 from the screen. In the television broadcast reception apparatus 100 according to this embodiment of the present invention, however, the program title of any program that is broadcast in a time period that at least partly overlaps with the time period (i.e., from 11:00 a.m. to 12:00 p.m.) of the previously scheduled program is, for example, displayed in a different color (e.g., gray) from that of the other program titles in the area 224. Alternatively, another method may be applied for varying a manner of display of the program title of any program that is broadcast in the overlapping time period, such as varying a character style of the program title, for example. In FIG. 4, frames of program titles of programs that are broadcast in time periods that overlap with the time period of the previously scheduled program are hatched.

For example, a program having a program title “Professional Baseball” broadcast on channel “101” is a program broadcast from 11:00 a.m. to 1:30 p.m., and overlaps in broadcast time period with the previously scheduled program (whose time period is from 11:00 a.m. to 12:00 p.m.). Therefore, the program title of this program is displayed in gray. Similarly, a program having a program title “Karaoke Hit” broadcast on channel “105” is a program broadcast from 11:30 a.m. to 1:00 p.m., and a program having a program title “Cinema” broadcast on channel “107” is a program broadcast from 11:00 a.m. to 1:00 p.m. Both the programs overlap in broadcast time period with the previously scheduled program (whose time period is from 11:00 a.m. to 12:00 p.m.). Therefore, program titles of both the programs are displayed in gray.

This prevents the user from attempting to schedule any program that overlaps in broadcast time with the previously scheduled program “News”, forgetting that the program “News” has been scheduled previously, for example.

Allowing the user to recognize the time period in which any program has been scheduled previously in the above-described manner eliminates the possibility that an error indication owing to overlapping of scheduled time periods will be displayed immediately before the user completes setting of new scheduling, for example, and thus prevents the user from having an impression of lack of usability.

Moreover, in the television broadcast reception apparatus 100 according to this embodiment of the present invention, when the user finds a program which he or she desires to newly schedule in a time period that at least partly overlaps with the time period in which any program has been scheduled previously, it is possible to cancel the setting of the previously scheduled program to schedule the newly found program.

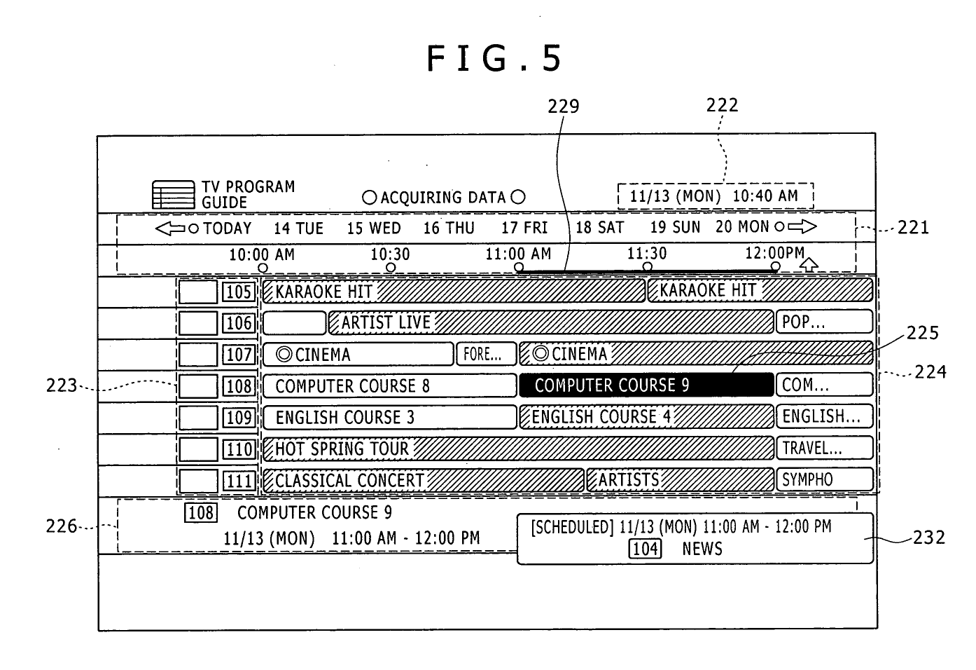

For example, referring to FIG. 5, when the previously scheduled program exists in a time period of the electronic program guide displayed on the screen, information concerning the previously scheduled program is displayed in an area 232. In FIG. 5, as the information concerning the previously scheduled program, information concerning the program “News” broadcast from 11:00 a.m. to 12:00 p.m. on channel “104” is being displayed.

Meanwhile, as the information of the program (i.e., the program “Computer Course 9”) at which the cursor 225 is located, the channel number, the program title, the broadcast date, and the program start and end times of this program are displayed in the area 226.

Further, the bar 229 is displayed at the lower portion of the area 221 to indicate the time period (i.e., from 11:00 a.m. to 12:00 p.m.) of the previously scheduled program, whereas the programs that are broadcast in the time periods that coincide or overlap with the time period of the previously scheduled program are displayed in gray in the area 224.

For example, by operating the cursor 225, the user is able to allow the program titles of both “Computer Course 9” which the user desires to newly schedule and the previously scheduled program to be displayed in the area 226 and the area 232, respectively, on the screen for checking. This makes is easy for the user to judge which of the two schedulings should be assigned a higher priority for setting.

In the case where there is a desire to cancel the scheduling of the previously scheduled program “News” and newly schedule the program “Computer Course 9”, the user is able to move the cursor 225 to the area 232 and perform a predetermined operation to cancel the scheduling of the program displayed in the area 232, for example (see FIG. 6).

Thus, lack of operability of a related-art recording scheduling function is overcome, for example. This lack of operability is as follows: when the aforementioned overlapping of scheduling has occurred, the user may desire to check the previously scheduled program that at least partly overlaps in time period with a program that the user has just attempted to schedule for recording using the electronic program guide, or cancel the scheduling of the previously scheduled program; and, in this case, the user has to switch to a screen displaying setting information concerning a recording schedule or the like, and, after completing the check or cancellation, cause the electronic program guide to be displayed again to start the new scheduling for recording afresh.

Next, with reference to a flowchart of FIG. 7, an electronic program guide display procedure by the television broadcast reception apparatus 100 according to this embodiment of the present invention will now be described below.

At step S101, the CPU 109 generates the image data of the electronic program guide, and allows the image corresponding to the generated image data to be displayed on the display or the like.

At step S102, the CPU 109 determines whether the setting of the scheduling of any program has been performed. If it is determined that the setting of the scheduling of any program has been performed, control proceeds to step S104.

At step S104, with respect to the image data of the electronic program guide generated by the process of step S101, the CPU 109 changes display of the time period of the program of which, the process of step S102 has determined, the setting of the scheduling has been performed. At this time, as described above with reference to FIGS. 2 and 3, for example, the image data is modified so that the bar 229 is displayed and that the program that is broadcast in a time period that at least partly overlaps with the time period of the program of which the setting of the scheduling has been determined is displayed in gray.

Moreover, at this time, the information of the program of which, the process of step S102 has determined, the setting of the scheduling has been performed may be displayed in the area 232 as illustrated in FIG. 5, for example.

As a result, with the image of the electronic program guide displayed on the display or the like, the user is able to recognize the time period in which any scheduling has been performed previously even if the screen is scrolled.

Meanwhile, if it is determined at step S102 that the setting of the scheduling of no program has been performed, control proceeds to step S103.

At step S103, the CPU 109 determines whether the scheduling of any previously scheduled program has been cancelled. If it is determined that the scheduling of no previously scheduled program has been cancelled, control returns to step S102.

Meanwhile, if it is determined at step S103 that the scheduling of any previously scheduled program has been cancelled, control proceeds to step S105.

At step S105, the CPU 109 returns the display of the time period of the previously scheduled program of which the scheduling has been cancelled to its original state. At this time, for example, the image data is modified so that the display of the bar 229 that has been displayed at the time period of the previously scheduled program of which the scheduling has been cancelled disappears, and that the program that is broadcast in a time period that at least partly overlaps with the time period of the program of which the cancellation of the scheduling has been determined is displayed not in gray but in its original color (e.g., white, black, or the like).

As described above, the electronic program guide is displayed such that the user is able to identify the time period in which any scheduling has been performed previously.

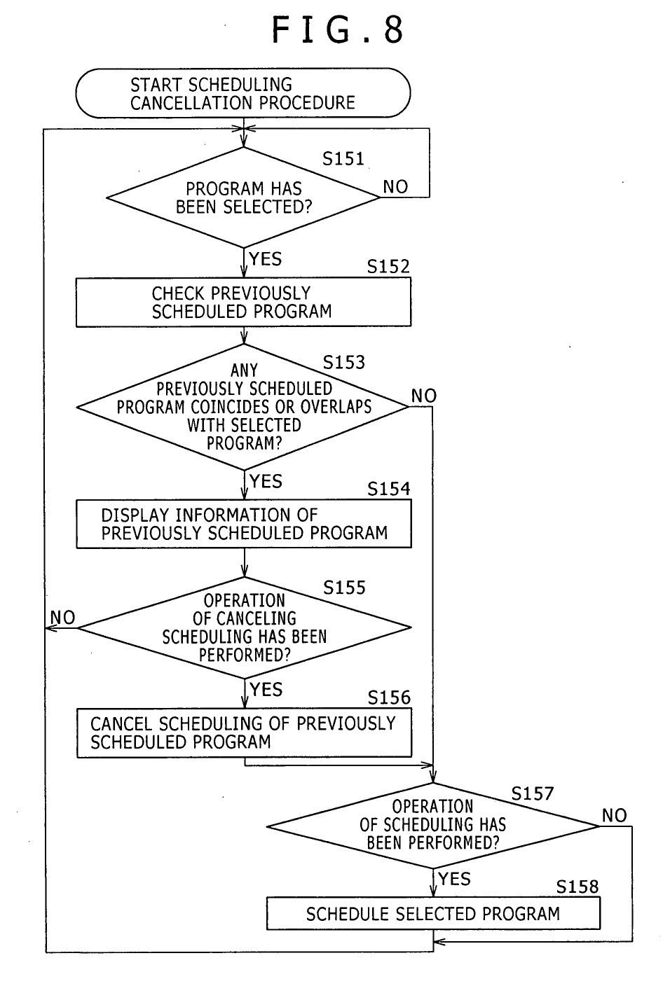

Next, with reference to a flowchart of FIG. 8, a scheduling cancellation procedure by the television broadcast reception apparatus 100 according to this embodiment of the present invention will now be described below. This procedure is performed when the electronic program guide is being displayed.

At step S151, the CPU 109 determines whether any program has been selected. The CPU 109 waits until it is determined that any program has been selected. For example, as described above with reference to FIG. 5, when the cursor 225 has been moved to a frame corresponding to a given program title displayed in the area 224, the program having that program title is determined to have been selected.

If it is determined at step S151 that any program has been selected, control proceeds to step S152. At step S152, the CPU 109 checks the previously scheduled program(s). At this time, the broadcast time period of the previously scheduled program(s) or the like is checked, for example.

At step S153, the CPU 109 determines whether the previously scheduled program(s) checked by the process of step S152 includes a program that at least partly overlaps in broadcast time period with the program that, the process of step S151 has determined, has been selected. If it is determined that no previously scheduled program at least partly overlaps in broadcast time period with the selected program, control proceeds to step S157.

At step S157, the CPU 109 determines whether the operation of scheduling has been performed on the program that, the process of step S151 has determined, has been selected. If it is determined at step S157 that the operation of scheduling has been performed thereon, the selected program is scheduled at step S158. As a result, it will be determined at step S102 in FIG. 7 that the setting of the scheduling of any program has been performed.

Meanwhile, if it is determined at step S153 that any previously scheduled program at least partly overlaps in broadcast time period with the selected program, control proceeds to step S154.

At step S154, the CPU 109 allows the information of the previously scheduled program to be displayed. At this time, as illustrated in FIG. 5, the image data of the electronic program guide is modified so that the information of the previously scheduled program is displayed in the area 232, and an image corresponding to the modified image data is displayed on the display or the like.

Note that in the case where the information of the previously scheduled program has already been displayed in the area 232 by the process of step S104 in FIG. 7, the display of the currently-displayed information of the previously scheduled program is maintained at step S154. Also note that in the case where there are multiple previously scheduled programs, for example, it is preferable that each time a given program is selected, information of a previously scheduled program that at least partly overlaps in broadcast time period with this selected program be displayed.

At step S155, the CPU 109 determines whether the operation of canceling the scheduling has been performed. If the operation of canceling the scheduling has been performed as described above with reference to FIG. 6, for example, it is determined at step S155 that the operation of canceling the scheduling has been performed, and control proceeds to step S156.

At step S156, the CPU 109 cancels the scheduling of the previously scheduled program (i.e., the previously scheduled program displayed in the area 232). As a result, it will be determined at step S103 in FIG. 7 that the scheduling of any program has been cancelled.

After the process of step S156, control proceeds to step S157, and the processes of steps S157 and S158 are performed as described above.

In the above-described manner, the setting or cancellation of the scheduling is performed.

Note that in the above-described embodiment, scheduling for recording has been taken as an example for description, primarily. However, the present invention is also applicable to scheduling for viewing in a similar manner.

Also note that in the above-described embodiment, the present invention is applied to the television broadcast reception apparatus. However, the present invention is also applicable to a Hard Disk Drive (HDD) recorder, a Digital Versatile Disk (DVD) recorder, and other devices.

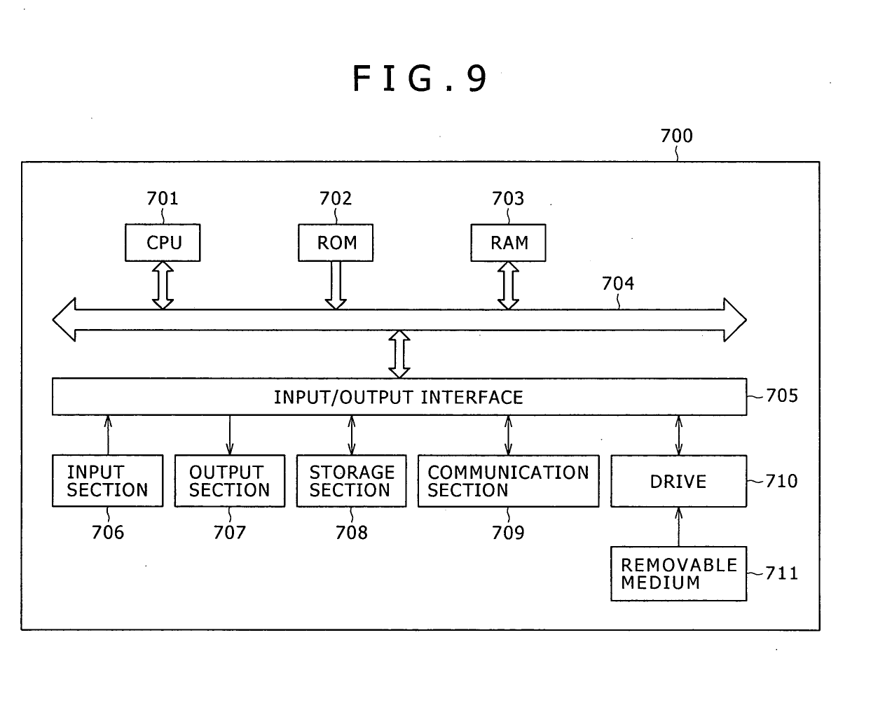

Also note that the above-described series of processes may be implemented by either hardware or software. In the case where the above-described series of processes is implemented by the software, a program that constitutes the software is installed, from a storage medium or a network, into a computer having a dedicated hardware configuration, a general-purpose personal computer 700 as illustrated in FIG. 9, for example, that, when various programs are installed therein, becomes capable of performing various functions, or the like.

In FIG. 9, a Central Processing Unit (CPU) 701 performs various processes in accordance with a program stored in a Read Only Memory (ROM) 702 or a program loaded from a storage section 708 to a Random Access Memory (RAM) 703. In the RAM 703, data necessary when the CPU 701 performs the various processes or the like is also stored as necessary.

The CPU 701, the ROM 702, and the RAM 703 are connected to one another via a bus 704. An input/output interface 705 is also connected to the bus 704.

To the input/output interface 705 are connected: an input section 706 including a keyboard, a mouse, or the like; an output section 707 including a display such as a Cathode Ray Tube (CRT), a Liquid Crystal Display (LCD), or the like, and a loudspeaker or the like; the storage section 708 including a hard disk or the like; and a communication section 709 including a network interface card such as a LAN card, a modem, or the like. The communication section 709 performs a communication process via the network such as the Internet.

A drive 710 is also connected to the input/output interface 705 as necessary. A removable medium 711, such as a magnetic disk, an optical disk, a magneto-optical disk, a semiconductor memory, or the like, is mounted on the drive 710 as necessary, so that a computer program read therefrom is installed into the storage section 708 as necessary.

In the case where the above-described series of processes is implemented by the software, the program that constitutes the software is installed from the network such as the Internet or the storage medium such as the removable medium 711.

Note that this storage medium is not limited to the removable medium 711 having the program stored therein as illustrated in FIG. 9, which is delivered separately from the device for providing the program to the user. Examples of the removable medium 711 include the magnetic disk (including a floppy disk (registered trademark)), the optical disk (including a Compact Disk-Read Only Memory (CD-ROM) and a Digital Versatile Disk (DVD)), the magneto-optical disk (including a Mini-Disk (MD) (registered trademark)), and the semiconductor memory. Alternatively, the storage medium may be the ROM 702, the hard disk contained in the storage section 708, or the like, which has the program stores therein and is delivered to the user together with the device that contains them.

Note that the steps in which the above-described series of processes are performed may naturally be performed chronologically in order of description but need not be performed chronologically. Some steps may be performed in parallel or independently of one another.

It should be understood by those skilled in the art that various modifications, combinations, sub-combinations and alterations may occur depending on design and other factors insofar as they are within the scope of the appended claims or the equivalents thereof.

What is claimed is:

1. A content reception apparatus for receiving content broadcast on a given channel in a given time period, the content reception apparatus comprising:
a display control section configured to control display of a screen for accepting scheduling of content to be received based on a program guide; and
a storage section configured to store information concerning the content to be received, the content having been scheduled by a user based on the display of the screen;
wherein said display control section controls to display a time period in which the previously scheduled content is broadcast, in a display style different from other time period(s) in the program guide displayed on the screen, and
said display control section controls to display the information concerning the previously scheduled content stored in said storage section in a predetermined area on the screen.

2. The content reception apparatus according to claim 1, wherein
in the case where an instruction for canceling the scheduling of the previously scheduled content is accepted, the instruction being from the user and based on the display of the screen, the information concerning the previously scheduled content being displayed in the predetermined area on the screen,
said storage section is allowed to store information of content that is broadcast in a time period that at least partly overlaps with the time period in which the previously scheduled content is broadcast.

3. A content reception method of a content reception apparatus for receiving content broadcast on a given channel in a given time period, the content reception method comprising the steps of:
displaying a time period in which content scheduled by a user based on display of a screen for accepting scheduling of content to be received based on a program guide is broadcast in a display style different from other time period(s) in the program guide displayed on the screen, information concerning the scheduled content being stored as information of the content to be received; and
displaying the information concerning the previously scheduled content in a predetermined area on the screen.

4. A computer-readable program for making a content reception apparatus for receiving content broadcast on a given channel in a given time period to execute a content reception process comprising the steps of:
displaying a time period in which content scheduled by a user based on display of a screen for accepting scheduling of content to be received based on a program guide is broadcast in a display style different from other time period in the program guide displayed on the screen, information concerning the scheduled content being stored as information of the content to be received; and
displaying the information concerning the previously scheduled content in a predetermined area on the screen.

5. A storage medium having stored the program according to claim 4.

6. A content reception apparatus for receiving content broadcast on a given channel in a given time period, the content reception apparatus comprising:
a display control section configured to control display of a screen for accepting scheduling of content to be received based on a program guide; and
a storage section configured to store information concerning the content to be received, the content having been scheduled by a user based on the display of the screen;
wherein said display control section controls to display content that is broadcast in a time period that at least partly overlaps with a time period in which the previously scheduled content is broadcast in different display style from other piece(s) of content in the program guide displayed on the screen, and
said display control section controls to display the information concerning the previously scheduled content stored in said storage section in a predetermined area on the screen.

7. The content reception apparatus according to claim 6, wherein
in the case where an instruction for canceling the scheduling of the previously scheduled content is accepted, the instruction being from the user and based on the display of the screen, the information concerning the previously scheduled content being displayed in the predetermined area on the screen,
said storage section is allowed to store information of the content that is broadcast in the time period that at least partly overlaps with the time period in which the previously scheduled content is broadcast.

8. A content reception method of a content reception apparatus for receiving content broadcast on a given channel in a given time period, the content reception method comprising the steps of:
displaying content that is broadcast in a time period that at least partly overlaps with a time period in which content scheduled by a user based on display of a screen for accepting scheduling of content to be received based on a program guide is broadcast in different display style from other piece(s) of content in the program guide displayed on the screen, information concerning the scheduled content being stored as information of the content to be received; and
displaying the information concerning the previously scheduled content in a predetermined area on the screen.

9. A computer-readable program for making a content reception apparatus for receiving content broadcast on a given channel in a given time period to execute a content reception process, the computer-readable program comprising the steps of:
displaying content that is broadcast in a time period that at least partly overlaps with a time period in which content scheduled by a user based on display of a screen for accepting scheduling of content to be received based on a program guide is broadcast in different display style from other piece(s) of content in the program guide displayed on the screen, information concerning the scheduled content being stored as information of the content to be received; and
displaying the information concerning the previously scheduled content in a predetermined area on the screen.

10. A storage medium having stored the program according to claim 9.

11. A content reception apparatus for receiving content broadcast on a given channel in a given time period, the content reception apparatus comprising:
a display control section configured to control display of a screen for accepting scheduling of content to be received based on a program guide; and
a storage section configured to store information concerning the content to be received, the content having been scheduled by a user based on the display of the screen;
wherein said display control section controls to display a time period in which the previously scheduled content is broadcast in different display style from other time period(s) in the program guide displayed on the screen, and also displays content that is broadcast in a time period that at least partly overlaps with the time period in which the previously scheduled content is broadcast in different display style from other piece(s) of content in the program guide displayed on the screen, and
said display control section displays the information concerning the previously scheduled content stored in said storage section in a predetermined area on the screen.

12. The content reception apparatus according to claim 11, wherein
in the case where an instruction for canceling the scheduling of the previously scheduled content is accepted, the instruction being from the user and based on the display of the screen, the information concerning the previously scheduled content being displayed in the predetermined area on the screen,
said storage section is allowed to store information of the content that is broadcast in the time period that at least partly overlaps with the time period in which the previously scheduled content is broadcast.

13. A content reception method of a content reception apparatus for receiving content broadcast on a given channel in a given time period, the content reception method comprising the steps of:
displaying a time period in which content scheduled by a user based on display of a screen for accepting scheduling of content to be received based on a program guide is broadcast in different display style from other time period(s) in the program guide displayed on the screen, information concerning the scheduled content being stored as information of the content to be received;
displaying content that is broadcast in a time period that at least partly overlaps with the time period in which the scheduled content is broadcast in different display style from other piece(s) of content in the program guide displayed on the screen; and
displaying the information concerning the previously scheduled content in a predetermined area on the screen.

14. A computer-readable program for making a content reception apparatus for receiving content broadcast on a given channel in a given time period to execute a content reception process, the computer-readable program comprising the steps of:
displaying a time period in which content scheduled by a user based on display of a screen for accepting scheduling of content to be received based on a program guide is broadcast in different display style from other time period(s) in the program guide displayed on the screen, information concerning the scheduled content being stored as information of the content to be received;
displaying content that is broadcast in a time period that at least partly overlaps with the time period in which the scheduled content is broadcast in different display style from other piece(s) of content in the program guide displayed on the screen; and
displaying the information concerning the previously scheduled content in a predetermined area on the screen.

15. A storage medium having stored the program according to claim 14.

16. A content reception apparatus for receiving content broadcast on a given channel in a given time period, the content reception apparatus comprising:
a display control section configured to control display of a screen for accepting scheduling of content to be received based on a program guide that is displayed in a state that allows scrolling at least in a time-axis direction; and
a storage section configured to store information concerning the content to be received, the content having been scheduled by a user based on the display of the screen;
wherein said display control section controls to display content that is broadcast in a time period that at least partly overlaps with a time period in which the previously scheduled content is broadcast in different display style from other piece(s) of content in the program guide displayed on the screen.

17. A content reception method of a content reception apparatus for receiving content broadcast on a given channel in a given time period, the content reception method comprising the step of:
displaying content that is broadcast in a time period that at least partly overlaps with a time period in which content scheduled by a user based on display of a screen for accepting scheduling of content to be received based on a program guide that is displayed in a state that allows scrolling at least in a time-axis direction is broadcast in different display style from other piece(s) of content in the program guide displayed on the screen, information concerning the scheduled content being stored as information of the content to be received.

18. A computer-readable program for making a content reception apparatus for receiving content broadcast on a given channel in a given time period to execute a content reception process, the computer-readable program comprising the step of:
displaying content that is broadcast in a time period that at least partly overlaps with a time period in which content scheduled by a user based on display of a screen for accepting scheduling of content to be received based on a program guide that is displayed in a state that allows scrolling at least in a time-axis direction is broadcast in different display style from other piece(s) of content in the program guide displayed on the screen, information concerning the scheduled content being stored as information of the content to be received.

19. A storage medium having stored the program according to claim,18.
